(19) United States
(12) Patent Application Publication
(10) Pub. No.: US 2011/0019405 A1
(43) Pub. Date: Jan. 27, 2011

(54) STREET LAMP

(75) Inventors: Chih-Chung Tsao, Chu-Nan (TW); Jung-Sung Cheng, Chu-Nan (TW); Su-Chi Chang, Chu-Nan (TW); Chih-Ming Lai, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/700,928

(22) Filed: Feb. 5, 2010

(30) Foreign Application Priority Data
Jul. 23, 2009 (CN) 200910304714.0

(51) Int. Cl. F21V 1/00; F21S 6/00; F21V 7/00; F21V 7/07

(52) U.S. Cl. 362/235; 362/257; 362/296.01; 362/296.07

(57) ABSTRACT

An exemplary street lamp includes a solid-state light source and a light guiding plate. The light source is used to emit light to illuminate a portion of the traffic lane. The illuminated portion includes a first section and a second section at opposite sides of the projection of the light source on the traffic lane. The solid-state light source defines a central axis perpendicular to a lengthwise direction of the traffic lane. The plate includes a light incident surface and a light output surface at opposite sides thereof. The plate is used to deviate the light from the light source. In this manner, a maximum light intensity in the first section is less than or equal to 60 percent of a maximum light intensity in the second section.

### BACKGROUND

1. Technical Field

The disclosure generally relates to street lamps, and particularly to a street lamp with anti-glare function.

2. Description of Related Art

Nowadays, light emitting diodes (LEDs) are extensively used as light sources due to their high luminous efficiency, low power consumption, and long lifespan. Although the bright light emitted by LEDs is useful to illuminate a dark environment, it can be uncomfortable and even painful if it shines directly into a person's eyes, as well as dangerous. For example, as shown in FIG. 16, in a typical application, the LEDs 101 are arranged in sequence along a horizontal direction and above a traffic lane 103 to provide overhead lighting. Because the LEDs 101 emit light radially, it may be difficult for a person 102 in a vehicle 104 to avoid looking directly at the light.

Therefore, what is needed is a street lamp that overcomes the described limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a street lamp in accordance with a first embodiment, the street lamp being applied to illuminate a traffic lane, and the street lamp including a solid-state light source and a light guiding plate.

FIG. 2 is an isometric view of the light guiding plate of FIG. 1.

FIG. 3 is a schematic view illustrating application of the street lamp of FIG. 1, as seen from a lateral view of the traffic lane.

FIG. 4 is a graph of light intensity distribution of the street lamp of FIG. 1.

FIG. 5 is similar to FIG. 3, but showing application of a street lamp in accordance with a second embodiment, the street lamp including a solid-state light source and a light guiding plate.

FIG. 6 is an isometric view of the light guiding plate of FIG. 6.

FIG. 7 is similar to FIG. 3, but showing application of a street lamp in accordance with a third embodiment, the street lamp including a solid-state light source and a light guiding plate.

FIG. 8 is an isometric view of the light guiding plate of FIG. 7.

FIG. 9 is similar to FIG. 3, but showing application of a street lamp in accordance with a fourth embodiment, the street lamp including a solid-state light source and a light guiding plate.

FIG. 10 is an isometric view of the light guiding plate of FIG. 9.

FIG. 11 is similar to FIG. 3, but showing application of a street lamp in accordance with a fifth embodiment, the street lamp including a solid-state light source and a light guiding plate.

FIG. 12 is an isometric view of the light guiding plate of FIG. 11.

FIG. 13 is similar to FIG. 3, but showing application of a street lamp in accordance with a sixth embodiment, the street lamp including a solid-state light source and a light guiding plate.

FIG. 14 is an isometric view of the light guiding plate of FIG. 13.

FIG. 15 is an isometric view of a street lamp, in accordance with a seventh embodiment.

FIG. 16 is a side view illustrating glare that can occur from light of typical LEDs.

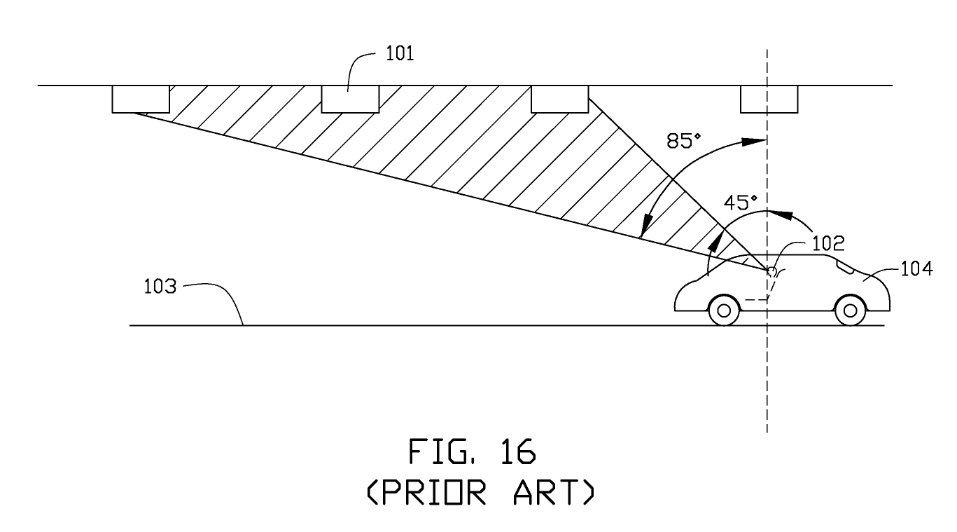

### DETAILED DESCRIPTION

Reference will now be made to the drawings to describe several embodiments of the street lamp, in detail.

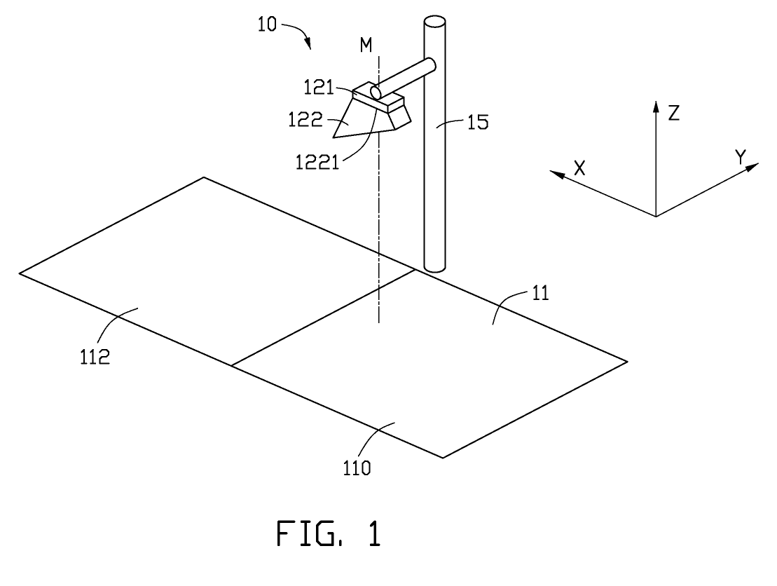

Referring to FIG. 1, a street lamp 10 according to a first embodiment, includes a solid-state light source 121 and a light guiding plate 122. The street lamp 10 is used to illuminate a traffic lane 11.

The light source 121 can be a LED. The LED can be a white LED for emitting white light. Alternatively, the LED may be another suitable LED for emitting a monochromatic light, such as red, green, blue, or yellow light. In addition, the light source 121 can be an LED chip. The light source 121 defines a central axis M parallel to a Z-axis of a defined Cartesian coordinate system, as shown in FIG. 1. In this embodiment, the Z-axis is perpendicular to the traffic lane 11. In alternative embodiments, the Z-axis may be perpendicular to a lengthwise direction of the traffic lane but not necessary to be perpendicular to the traffic lane 11.

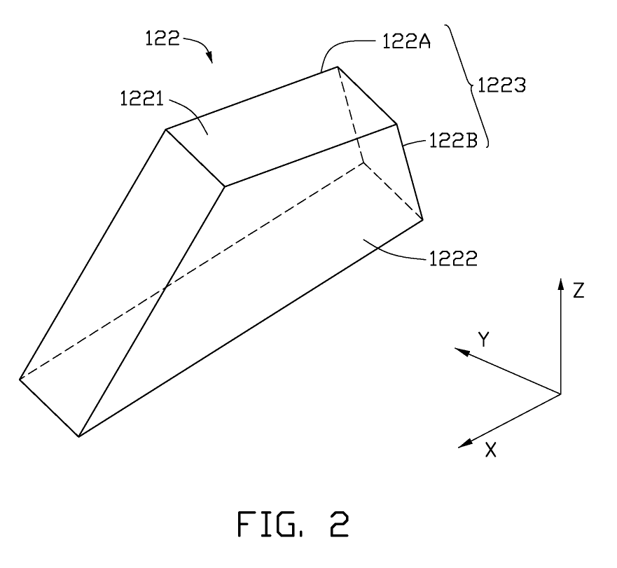

The plate 122 can be made of light-pervious material, such as resin, silicone, epoxy, polyethylene terephthalate, polymethyl methacrylate, or polycarbonate. Alternatively, the plate 122 can be made of glass, or other suitable materials. Referring also to FIG. 2, the plate 122 is prismoid-shaped, and includes a light incident surface 1221 and a light output surface 1222 at two opposite sides thereof, and a peripheral side surface 1223. The peripheral side surface 1223 is located between and adjoins both the light incident surface 1221 and the light output surface 1222. In this embodiment, the light incident surface 1221 is a rectangular plane surface. The light output surface 1222 is a plane surface inclined relative to the light incident surface 1221, and the light output surface 1222 is slanted toward positive X-axis direction. The peripheral side surface 1223 is comprised of two parallel plane surfaces 122A and two inclined flat surfaces 122B. The two plane surfaces 122A each are perpendicular to the light incident surface 1221. The two inclined flat surfaces 122B each are inclined relative to the light incident surface 1221. Each of the plane surfaces 122A and the inclined flat surfaces 122B extends from a periphery of the rectangular light incident surface 1221 and adjoins the light output surface 1222.

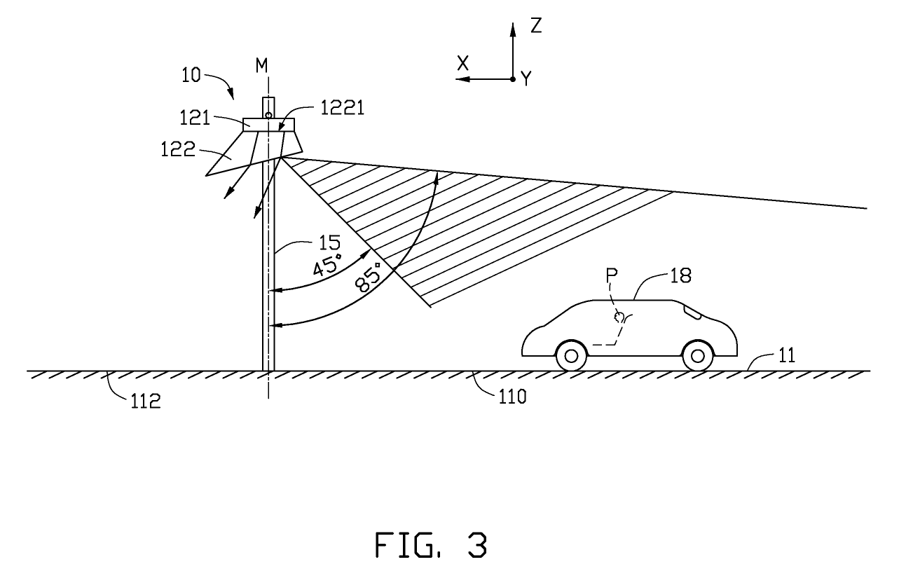

Referring also to FIG. 3, the street lamp 10 further includes a lamp post 15 for holding the light source 121 and the plate 122. In this embodiment, the lamp post 15 is arranged adjacent to the traffic lane 11. The light source 121 is attached to the plate 122 and intimately contacts the light incident surface 1221, and the light source 121 is fixed to an end of the lamp post 15 far away from the traffic lane 11. In such that, the light source 121 and the plate 122 are located above the traffic lane 11. The light source 121 emits light to transmit through the plate 122 and illuminate a portion of the traffic lane 11. The illuminated portion includes a first section 110 and a second section 1122 at opposite sides of the projection of the light source 121 on the traffic lane 11. FIG. 3 also shows a vehicle 18 is driven by a driver P. The vehicle 18 currently travels in the first section 110 of the traffic lane 11 and is about to passing through the first section 110 thus approaching the second section 112.

In operation, when electric current is applied to the light source 121, the light source 121 emits light. The light enters the plate 122 through the light incident surface 1221 and passes through the plate 122. The plate 122 refracts the light along an X-axis direction. The X-direction is parallel to the lengthwise direction of the traffic lane 11. Generally, the light output surface 1222 provides refracted light that exits the plate 122. Overall, the plate 122 deviates the light from the central axis M of the light source 121 along the positive X-axis direction. A light intensity on the lane 11 is generally not uniform. A maximum light intensity in the second section 112 is beneficially greater than a maximum light intensity in the first section 110. Generally, if the maximum light intensity in the first section 110 is less than or equal to 60 percent of the maximum light intensity in the second section 112, glare can be avoided. The second section 112 includes a portion illuminated by light beams emitted at an illumination angle of from about 45 degrees to about 85 degrees (see FIG. 3). The term “illumination angle” means an angle between a light beam and the central axis M. Preferably, the maximum light intensity in the first section 110 is less than or equal to 20 percent of the maximum light intensity in the portion of the second section 112. The glare can be avoided by recuding the maximum light intensity in the first section 110.

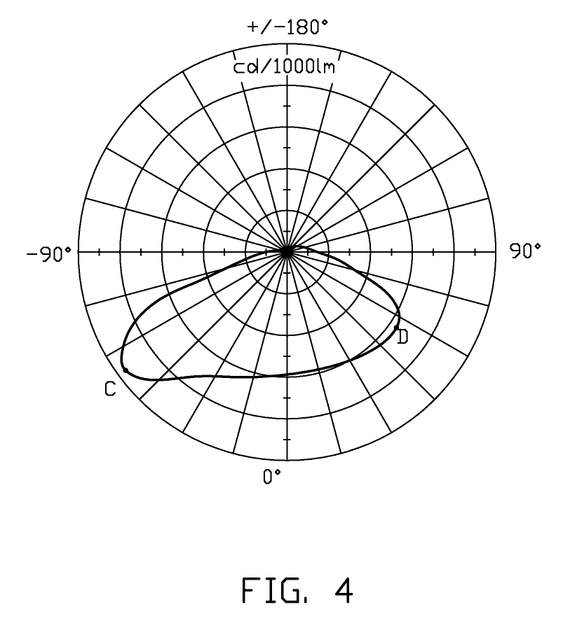

FIG. 4 is a graph illustrating light intensity distribution of the street lamp of FIG. 1 in one example. A point C in the graph illustrates that the maximum light intensity in the second section 112 is about 950 candela (cd). In contrast, a point D in the graph illustrates the maximum light intensity in the first section 110 is about 550 cd. When the driver P in the vehicle 18 travels at the first section 110, light with high intensity (for example, light intensity of more than 550 cd) can not directly enter the driver P's eyes, thus he/she is liable to avoid experiencing uncomfortable glare. Furthermore, when the driver P approaches at the second section 112, he/she can also avoid experiencing uncomfortable glare, because the plate 122 deviates light from the light source 121 along the positive X-axis direction, and the X-axis direction is opposite to a viewing direction of the driver P's eyes.

The peripheral side surface 1223 may have a reflective layer (not labeled) formed thereon. The reflective layer can reflect light thereon. Therefore, at least part of the reflected light may be recycled in the plate 122 and eventually refracted by the plate 122 to exit the light output surface 1222. As such, light utilization efficiency of the light source 121 is enhanced.

It is noted that the street lamp 10 is not limited to have the above-mentioned first embodiment, the street lamp described in below embodiments, are acceptable as well.

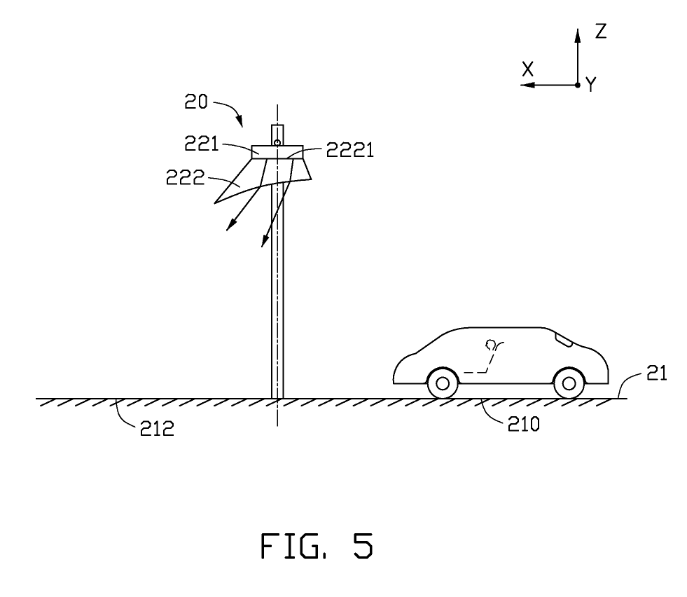

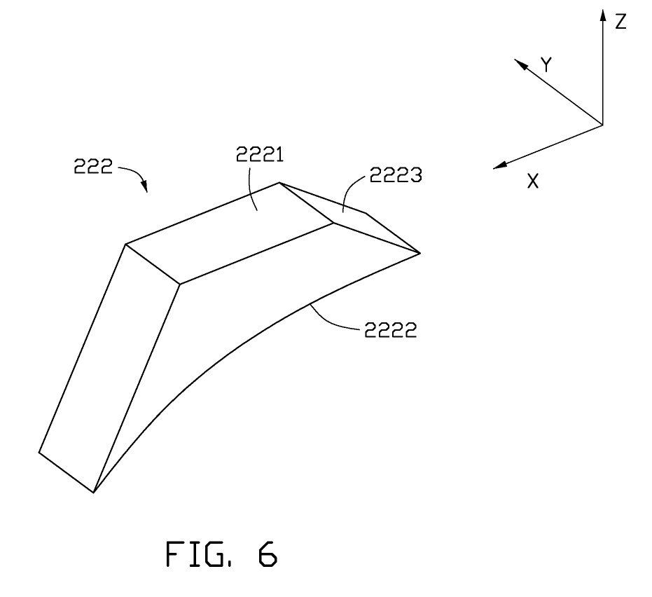

Referring to FIGS. 5 and 6, a street lamp 20, in accordance with a second embodiment, is shown. The street lamp 20 is similar to the street lamp 20 of the first embodiment in structure and principle, and includes a solid-state light source 221 and a light guiding plate 222. The light guiding plate 222 includes a light incident surface 2221, a light output surface 2222, and a peripheral side surface 2223. The street lamp 20 differs from the street lamp 10 in that the light output surface 2222 is not a plane surface. Instead, the light output surface 2222 is an arc-shaped surface, such as a concave surface with an arc generatrix extending parallel to a Y-axis perpendicular to the XZ plane. Preferably, a gradient of the second surface portion 212 increases gradually along a positive X-axis direction.

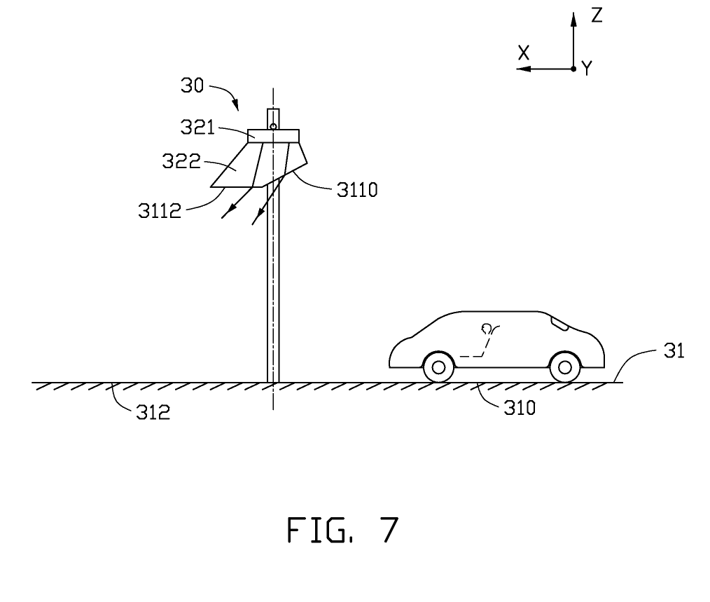

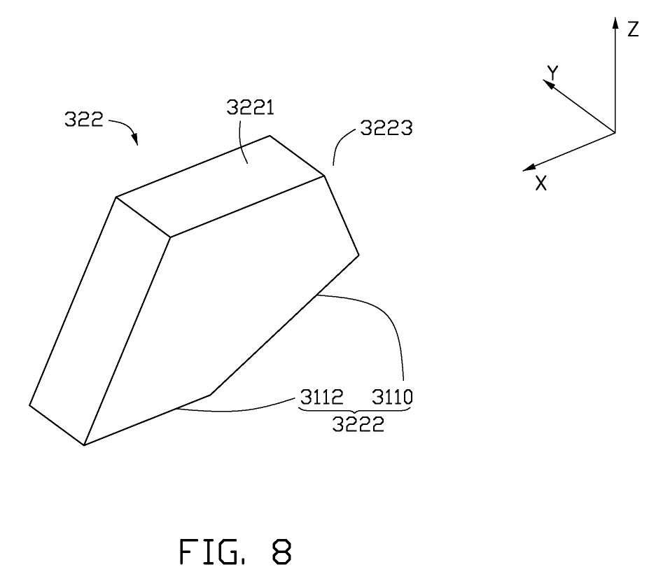

Referring to FIGS. 7 and 8, a street lamp 30, in accordance with a third embodiment, is shown. The street lamp 30 is similar to the street lamp 10 of the first embodiment in structure and principle, and includes a solid-state light source 321 and a light guiding plate 322. The light guiding plate 322 includes a light incident surface 3221, a light output surface 3222, and a peripheral side surface 3223. The street lamp 30 differs from the street lamp 10 in that the light output surface 3222 is not a plane surface. Instead, the light output surface 3222 includes a first surface portion 3110, and a second surface portion 3112 adjoining the first surface portion 3110. The first surface portion 3110 is located at a side of the plate 322 adjacent to the first section 310 of the traffic lane 31. The second surface portion 3112 is located at another side of the plate 322 farther away from the first section 310. That is, the second surface portion 3112 is located adjacent to the second section 312 of the traffic lane 31. In particular, the first surface portion 3110 is an inclined flat surface relative to the light incident surface 3221, and the first surface portion 3110 is slanted toward a positive X-axis direction. The second surface portion 3112 is parallel to the light incident surface 3221.

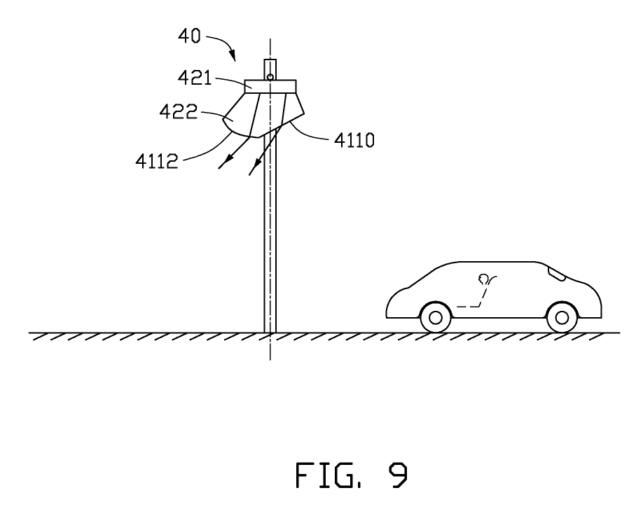

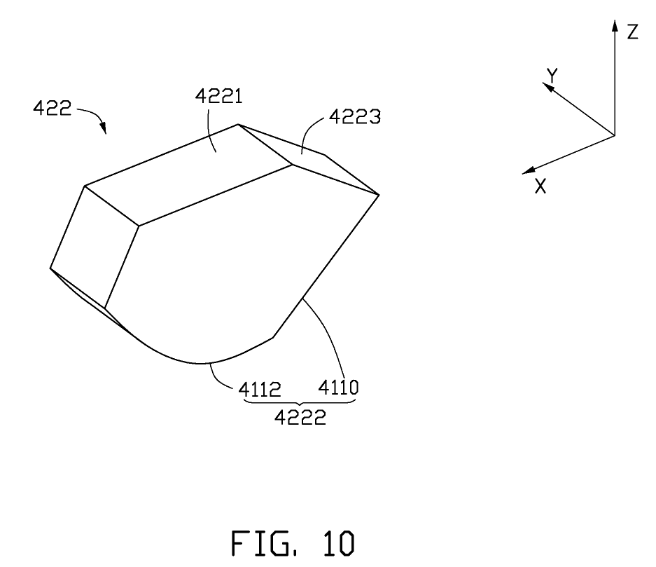

In alternative embodiments, the light output surface 3222 may be in other forms. For example, as shown in FIGS. 9 and 10, a street lamp 40 according to a fourth embodiment includes a solid-state light source 421 and a light guiding plate 422. The light guiding plate 422 includes a light incident surface 4221, a light output surface 4222, and a peripheral side surface 4223. The light output surface 4222 includes a first surface portion 4110, and a second surface portion 4112. The street lamp 40 differs from the street lamp 30 in that the first surface portion is an inclined flat surface relative to the light incident surface 4221, and the second surface portion 4112 is an arc-shaped surface. In particular, the second surface portion 4112 is a convex surface with an arc generatrix extending parallel to the Y-axis.

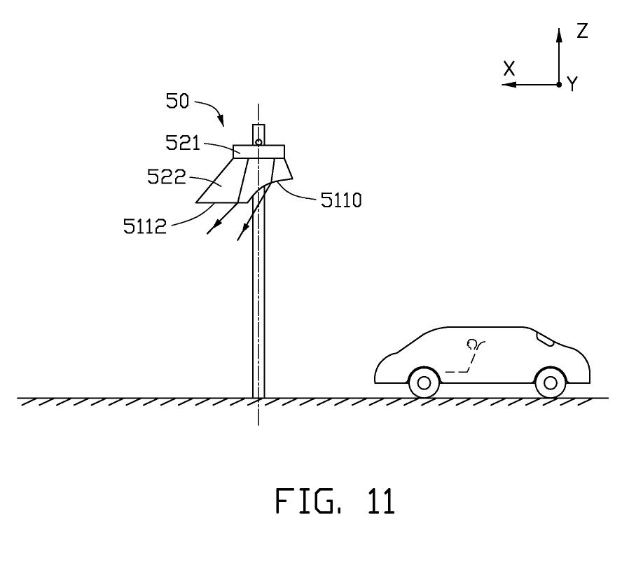

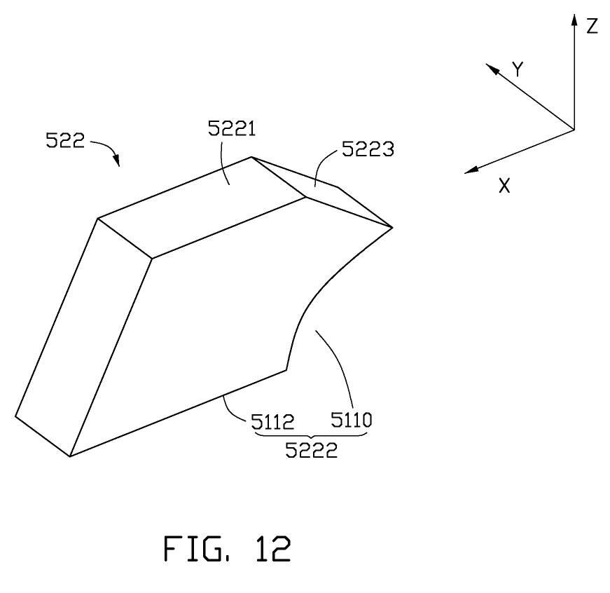

Referring to FIGS. 11 and 12, a street lamp 50 in accordance with a fifth embodiment, includes a solid-state light source 521 and a light guiding plate 522. The light guiding plate 522 includes a light incident surface 5221, a light output surface 5222, and a peripheral side surface 5223. The light output surface 5222 includes a first surface portion 5110, and a second surface portion 5112. The street lamp 50 differs from the street lamp 30 in that the first surface portion 5110 is an arc-shaped surface, and the second surface portion 5112 is a plane surface substantially parallel to the light incident surface 5221. In particular, the first surface portion 5110 is a concave surface with an arc generatrix extending parallel to the Y-axis, and a gradient of the first surface portion 5112 increases gradually along a positive X-axis direction.

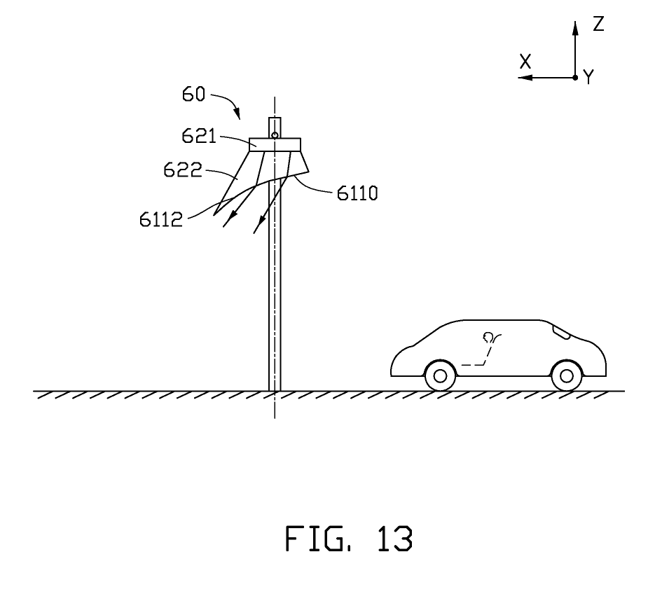

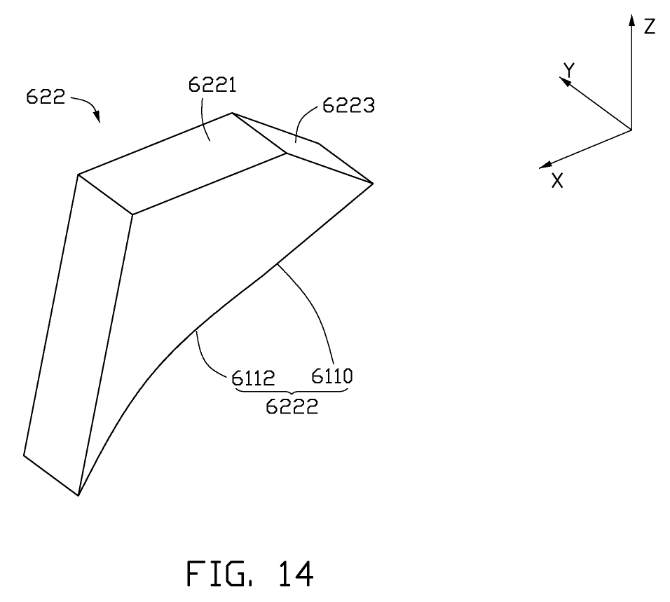

Referring to FIGS. 13 and 14, a street lamp 60 in accordance with a sixth embodiment, includes a solid-state light source 621 and a light guiding plate 622. The light guiding plate 622 includes a light incident surface 6221, a light output surface 6222, and a peripheral side surface 6223. The light output surface 6222 includes a first surface portion 6110, and a second surface portion 6112. The street lamp 60 differs from the street lamp 30 in that the second surface portion 6112 is an arc-shaped surface. In particular, the second surface portion 6112 is a concave surface with an arc generatrix extending parallel to the Y-axis, and a gradient of the second surface portion 6112 increases gradually along a positive X-axis direction.

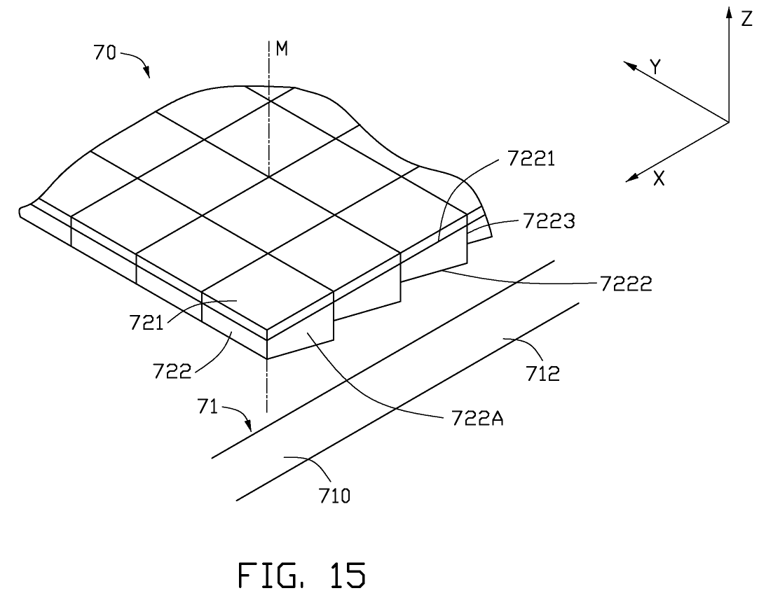

Referring to FIG. 15, a street lamp 70 in accordance with a seventh embodiment, is shown. The street lamp 70 includes a solid-state light member 721, and a plurality of light guiding units 722 arranged in columns and rows. In this embodiment, the solid-state light member 721 includes a plurality of LEDs (not labeled) and defines a central axis M. The number of the light guiding units 722 equals to that of the solid-state light sources 721. Each of the LEDs is arranged on a corresponding light guiding unit 722, and includes a light incident surface 7221, a light output surface 7222, and a peripheral side surface 7223. The light guiding unit 722 is similar to the plate 122 of the first embodiment in structure and principle, except that the peripheral side surface 7223 includes four plane surfaces 722A with each perpendicular to the light incident surface 7221. Each of the four plane surfaces 722A extends from a periphery of the rectangular light incident surface 7221 and adjoins the light output surface 7222. All the light incident surface 7221 are coplanar. In this embodiment, the light guiding units 722 are formed separately and then assembled together, and the peripheral side surface 7223 of each unit 722 intimately contacts the peripheral side surface 7223 of a neighboring unit 722. Alternatively, the light guiding units 722 can be integrally formed.

In operation, each LED emits light to the corresponding unit 722. All the units 722 deviate the light from the central axis M along the positive X-axis directions.

Thus, a maximum light intensity in a second section 712 is essentially greater than the maximum light intensity measured at the first section 710.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A street lamp for mounting on a traffic lane and illuminating the traffic lane, the street lamp comprising:
a solid-state light source configured for emitting light to illuminate a portion of the traffic lane, the illuminated portion comprising a first section and a second section at opposite sides of the projection of the light source on the traffic lane, and the solid-state light source defining a central axis perpendicular to a lengthwise direction of the traffic lane; and
a light-pervious light guiding plate comprising a light incident surface and a light output surface at opposite sides thereof, the light incident surface configured for receiving the light from the light source, and the light output surface configured for emission of the light to the traffic lane, the light guiding plate configured for deviating the light from the light source in a manner such that a maximum light intensity in the first section is less than or equal to 60 percent of a maximum light intensity in the second section.

2. The street lamp of claim 1, wherein the second section includes a portion illuminated by the light at an illumination angle of from about 45 degrees to about 85 degrees, the maximum light intensity in the first section is less than or equal to 20 percent of the maximum light intensity in the portion of the second section.

3. The street lamp of claim 1, wherein the light incident surface is a plane surface parallel to the lengthwise direction of the traffic lane.

4. The street lamp of claim 3, wherein the plate comprises a peripheral side surface located between and adjoining the light incident surface and the light output surface, and the light incident surface is rectangular, the peripheral side surface comprises two parallel plane surfaces each substantially perpendicular to the light incident surface, and two inclined flat surfaces relative to the light incident surface, and each of the plane surfaces and the inclined flat surfaces extends from a periphery of the light incident surface and adjoins the light output surface.

5. The street lamp of claim 4, wherein the peripheral side surface has a reflective layer formed thereon.

6. The street lamp of claim 3, wherein the light output surface includes a first surface portion at a side of the plate adjacent to the first section of the lane, and a second surface portion at another side of the plate farther away from the first section, at least the first surface portion is an inclined flat surface relative to the light incident surface, and the inclined flat surface is slanted toward the second section of the lane.

7. The street lamp of claim 6, wherein the entire light output surface is an inclined flat surface relative to the light incident surface.

8. The street lamp of claim 6, wherein the second surface portion is a plane surface parallel to the light incident surface.

9. The street lamp of claim 6, wherein the second surface portion is an arc-shaped surface with an arc generatrix extending perpendicularly to the lengthwise direction of the lane.

10. The street lamp of claim 9, wherein the second surface portion is a convex surface.

11. The street lamp of claim 9, wherein the second surface portion is a concave surface, and a gradient of the second surface portion increases gradually along a direction from the first section toward the second section.

12. The street lamp of claim 3, wherein the light output surface includes a first surface portion at a side of the plate adjacent to the first section of the lane, and a second surface portion at another side of the plate farther away from the first section, at least the second surface portion is a concave surface with an arc generatrix perpendicularly to the lengthwise direction of the lane, and a gradient of the first surface portion increases gradually along a direction from the first section toward the second section.

13. The street lamp of claim 12, wherein the entire light output surface is a concave surface, and a gradient of the light output surface increases gradually along a direction from the first section toward the second section.

14. The street lamp of claim 12, wherein the second surface portion is a plane surface parallel to the light incident surface.

15. The street lamp of claim 1, wherein the plate is made of material selected from the group consisting of resin, silicone, glass, polyethylene terephthalate, polymethyl methacrylate, and polycarbonate.

16. The street lamp of claim 1, wherein the light source comprises one of a light emitting diode and a light emitting diode chip.

17. A street lamp for mounting on a traffic lane and illuminating the traffic lane, the street lamp comprising:
a plurality of solid-state light sources configured for emitting light to illuminate a portion of the traffic lane, the illuminated portion comprising a first section and a second section at opposite sides of the projection of the light sources on the traffic lane, and each of the solid-state light sources defining a central axis perpendicular to a lengthwise direction of the traffic lane; and
a light-pervious light guiding plate comprising a plurality of light guiding units arranged in columns and rows, each of the units arranged adjacent to a corresponding solid-state light source and comprising a light incident surface and a light output surface at opposite sides thereof, the light incident surface configured for receiving the light from the solid-state light source, and the light output surface configured for emission of the light to the traffic lane, the units configured for deviating the light from the light sources in a manner such that a maximum light intensity in the first section is less than or equal to 60 percent of a maximum light intensity in the second section.

18. The street lamp of claim 17, wherein the light incident surface of each light source is a plane surface parallel to the lengthwise direction of the traffic lane, and all the light incident surfaces of the light guiding plate are coplanar.

19. The street lamp of claim 18, wherein each unit comprises a peripheral side surface located between and adjoining the light incident surface and the light output surface, and the light incident surface is rectangular, the peripheral side surface comprises four plane surfaces each substantially perpendicular to the light incident surface, and each of the plane surfaces extends from a periphery of the light incident surface and adjoins the light output surface.
